(19) United States
(12) Patent Application Publication
(10) Pub. No.: US 2026/0221060 A1
(43) Pub. Date: Jul. 30, 2026

(54) ELECTRONIC DEVICE AND METHOD FOR CONTROLLING SAME

(71) Applicant: Samsung Electronics Co., Ltd., Suwon-si (KR)

(72) Inventors: Junyoung IM, Suwon-si (KR); Joayoung LEE, Suwon-si (KR); Eunha CHOI, Suwon-si (KR); Changmo YANG, Suwon-si (KR); Younju JIN, Suwon-si (KR)

(21) Appl. No.: 19/573,376

(22) Filed: Mar. 20, 2026

Related U.S. Application Data
(63) Continuation of application No. PCT/KR2024/096198, filed on Sep. 19, 2024.

(30) Foreign Application Priority Data
Sep. 20, 2023 (KR) 10-2023-0125723

(51) Int. Cl. G09G 3/00

(52) U.S. Cl. CPC G09G 3/001; G09G 2340/0442; G09G 2340/045; G09G 2354/00

(57) ABSTRACT

An electronic device comprises: a communication interface; a projection unit; a memory storing information about a projection range ratio for each aspect ratio of content provided to an external display device; and at least one processor, comprising processing circuitry, that, when image information and aspect ratio information corresponding to the content displayed on the external display device are received via the communication interface, identify a projection area on the basis of the received aspect ratio information corresponding to the content and information stored in the memory, identify a projection image to be output to the projection area on the basis of the aspect ratio information corresponding to the content, the image information, and the information stored in the memory, and control the projection unit so that the identified projection image is output to the identified projection area.

### CROSS-REFERENCE TO RELATED APPLICATIONS

This application is a continuation of International Application No. PCT/KR2024/096198 designating the United States, filed on September 19, 2024, in the Korean Intellectual Property Receiving Office and claiming priority to Korean Patent Application No. 10-2023-0125723, filed on September 20, 2023, in the Korean Intellectual Property Office, the disclosures of each of which are incorporated by reference herein in their entireties.

### BACKGROUND

### Field

The disclosure relates to an electronic apparatus and a control method thereof, and for example, to an electronic apparatus providing expanded contents based on a link with an external device, considering aspects ratios of contents and an object within a projection surface, and a control method thereof.

### Description of Related Art

With the advancement in electronic technologies, various types of electronic apparatuses have been developed and provided. Meanwhile, in the case of a display of contents of an aspect ratio different from an aspect ratio of a manufactured display device, the contents may be displayed together with a letter box, causing a problem such as a wasted area in a display. To address the problem, required is a method in which a projector linked with a display device is used to display contents, thereby providing, to users, contents with no letter box.

### SUMMARY

An electronic apparatus according to an example embodiment may include: a communication interface comprising communication circuitry, a projection unit including a projector, memory storing information on a projection range ratio with respect to each aspect ratio of contents provided to an external display device, and at least one processor, comprising processing circuitry, individually and/or collectively, configured to cause the electronic apparatus to: identify, based on aspect ratio information and image information corresponding to contents displayed on the external display device being received through the communication interface, a projection area according to the received aspect ratio information corresponding to contents and information stored in the memory.

At least one processor, individually and/or collectively, may be configured to cause the electronic apparatus to identify, based on the aspect ratio information corresponding to contents, the image information and the information stored in the memory, a projection image to be output to the projection area.

At least one processor, individually and/or collectively, may be configured to cause the electronic apparatus to control the projection unit to output the identified projection image to the identified projection area.

A method of controlling an electronic apparatus according to an example embodiment may include: identifying, based on aspect ratio information and image information corresponding to contents displayed on an external display device being received, a projection area according to the received aspect ratio information corresponding to contents and information on a projection range ratio with respect to each aspect ratio of contents provided to the external display device, which is stored in memory.

The method may include identifying, based on the aspect ratio information corresponding to contents, the image information and the information stored in the memory, a projection image to be output to the projection area.

The method may include outputting the identified projection image to the identified projection area.

According to an example embodiment, a non-transitory computer-readable recording medium storing computer instructions is provided, wherein the instructions, when executed by at least one processor, comprising processing circuitry, of an electronic apparatus, individually and/or collectively, cause the electronic apparatus to perform operations, including: identifying, based on aspect ratio information and image information corresponding to contents displayed on an external display device being received, a projection area according to the received aspect ratio information corresponding to contents and information on a projection range ratio with respect to each aspect ratio of contents provided to the external display device, which is stored in memory.

The operations may include identifying, based on the aspect ratio information corresponding to contents, the image information and the information stored in the memory, a projection image to be output to the projection area.

The operations may include outputting the identified projection image to the identified projection area.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example control method of an electronic apparatus according to various embodiments;

FIG. 2 is a block diagram illustrating an example configuration of an electronic apparatus according to various embodiments;

FIG. 3 is a flowchart illustrating an example control method of an electronic apparatus according to various embodiments;

FIGS. 4A, 4B and 4C are diagrams illustrating an example method of displaying a projection image according to various embodiments;

FIG. 5 is a diagram illustrating an example method of identifying a first area and a second area according to various embodiments;

FIG. 6 is a diagram illustrating an example method of identifying a viewing obstruction area according to various embodiments;

FIG. 7 is a diagram illustrating an example method of outputting a guide user interface (UI) according to various embodiments;

FIGS. 8A and 8B are diagrams illustrating an example method of outputting an image according to various embodiments;

FIG. 9 is a flowchart illustrating an example method of controlling an electronic apparatus according to various embodiments;

FIG. 10 is a flowchart illustrating an example method of re-identifying a projection image and a display image according to various embodiments;

FIG. 11 is a diagram illustrating an example method of providing a UI menu according to various embodiments; and

FIG. 12 is a block diagram illustrating an example configuration of an electronic apparatus according to various embodiments.

### DETAILED DESCRIPTION

Hereafter, the disclosure is described in greater detail with reference to the accompanying drawings.

Terms used herein are schematically described, and then the subject matter of the disclosure is described in greater detail.

General terms currently used as widely as possible are selected as the terms used in the various embodiments of the disclosure considering their functions in the disclosure, but may be changed based on the intention of those skilled in the art or a judicial precedent, the emergence of a new technology, or the like. Additionally, in a specific case, arbitrary terms may be included in the terms used herein. In this case, the meanings of such terms are described in detail in the corresponding disclosure. Therefore, the terms used in the disclosure should be defined based on meanings thereof and particulars throughout the disclosure rather than simply names thereof.

In the disclosure, the expression "have”, "may have”, "include”, "may include" or the like, indicates the existence of a corresponding feature (e.g., a numerical value, a function, an operation or an element such as a part), and does not exclude the existence of an additional feature.

The expression of at least one from A or/and B is to be understood as indicating any one of “A” or “B” or “A and B”.

The expression “1st”, “2nd”, "first”, "second”, or the like, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to” or “connected with/to” another element (e.g., a second element), one element is to be understood as being connect to another element directly, or through yet another element (e.g., a third element).

In the disclosure, singular forms include plural forms as well, unless explicitly indicated otherwise. In the disclosure, the term “include” or “comprised of” and the like specify the presence of stated features, numbers, steps, operations, elements, components or combinations thereof but do not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. Additionally, a plurality of “modules” or a plurality of “units” may be integrated into at least one module and be implemented by at least one processor (not illustrated) excluding a “module” or a “unit” that needs to be implemented by specific hardware.

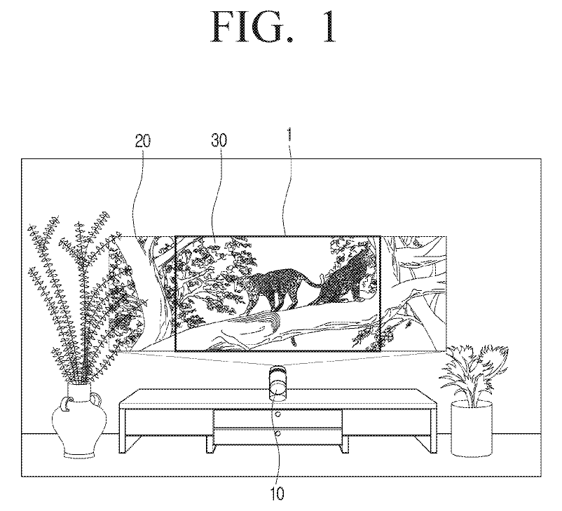

FIG. 1 is a diagram illustrating an example method of controlling an electronic apparatus according to various embodiments.

Referring to FIG. 1, based on aspect ratio information of contents 30 displayed on an external display device 1 being received, an electronic apparatus 10 may identify, based on this, a projection area corresponding to an image to be projected through the electronic apparatus 10 within a projection surface, according to an embodiment. The projection surface may be a portion of a physical space in which the image is output or a predetermined area in the physical space. As an example, the electronic apparatus 10 may identify projection range ratio information corresponding to an aspect ratio of the contents, and based on an identified projection range ratio, identify the projection area corresponding to the image to be projected through the electronic apparatus 10. The projection range ratio may be an aspect ratio value corresponding to a projection image output through an electronic apparatus 100.

According to an embodiment, the electronic apparatus 10 may identify a projection image 20 to be projected through the electronic apparatus 10 based on image information of contents and image information corresponding to contents. The electronic apparatus 10 may output the identified projection image 20 to the identified projection area within the projection surface.

Hereafter, described are various example embodiments of providing expanded contents to the user based on a link with the external display device 1, by displaying, in the predetermined area within the projection surface, part (or the projection image 20) of the contents 30 displayed on the external display device 1 according to the aspect ratio of the contents 30 and the projection range ratio.

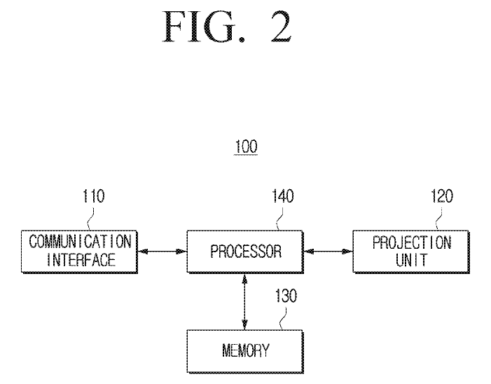

FIG. 2 is a block diagram illustrating an example configuration of an electronic apparatus according to various embodiments.

Referring to FIG. 2, the electronic apparatus 100 may include a communication interface (e.g., including communication circuitry) 110, a projection unit (e.g., including a projector) 120, memory 130 and at least one processor (e.g., including processing circuitry) 140.

An electronic apparatus 100 may be implemented as a projector according to an embodiment, but is not limited thereto, and certainly, may be implemented as different types of devices provided with a function of projecting an image, e.g., a projection function.

The electronic apparatus 100 may be communicably connected with an external display device based on various methods. According to an embodiment, a communication module for communicating with the external display device may be implemented identically. For example, the electronic apparatus 100 may communicate with the external display device using a Bluetooth module. According to an embodiment, the external display device may be implemented as various types of devices such as a smart TV, a tablet, a monitor, a smartphone, a desktop computer, a laptop computer and the like that are provided with a display. The external display device according to an embodiment is not limited to the above devices, and the external display device may be implemented as an external display device having two or more functions of the above devices.

According to an embodiment, the communication interface 110 may include various embodiments input and output various types of data. For example, the communication interface 110 may transceive various types of data with an external device (e.g., a source device), an external storage medium (e.g., USB memory), an external server (e.g., a webhard) based on a communication method such as AP-based Wi-Fi (Wi-Fi, Wireless LAN Network), Bluetooth, Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial and the like.

As an example, the communication interface 110 may include a Bluetooth Low Energy (BLE) module. The BLE may refer, for example, to a Bluetooth technology enabling transmission and reception of low-power low-capacity data in a 2.4-GHz frequency band having a reach radius of about 10 m. However, the communication interface 110 may not be limited thereto, and may include a Wi-Fi communication module. That is, the communication interface 110 may include at least one of a Bluetooth Low Energy (BLE) module or a Wi-Fi communication module.

According to an embodiment, the projection unit 120 may include a projector and perform a function of projecting light for expressing an image outward and outputting the image to a projection surface. The projection surface may be a portion of the physical space in which the image is output or a predetermined area within the physical space. The projection unit 120 may include various types of specific elements such as at least one light source among a lamp, a LED and a laser, a projection lens, a reflector and the like. The projection unit 120 may project the image based on one of various projection methods (e.g., cathode-ray tube (CRT) method, a liquid crystal display (LCD) method, a digital light processing (DLP) method, a laser method and the like). The projection unit 120 may include at least one light source. The projection unit 120 may output the image at a 4:3 screen ratio, a 5:4 screen ratio, a wide 16:9 screen ratio based on the usage of the electronic apparatus 100 or user settings and the like, but not be limited thereto. The projection unit 120 may output the image in various resolutions such as WVGA(854*480), SVGA(800*600), XGA(1024*768), WXGA(1280*720), WXGA(1280*800), SXGA(1280*1024), UXGA(1600*1200), Full HD(1920*1080) and the like, based on a screen ratio. Additionally, the projection unit 120 may perform various functions for adjusting the projection image under the control of the processor 140. For example, the projection unit 120 may perform a zoom function, a lens shift function and the like.

According to an embodiment, the memory 130 may store data required for various embodiments. The memory 130 may store data required for various embodiments. The memory 130 may be implemented in the form of memory embedded in the electronic apparatus 100 or in the form of memory detachable from the electronic apparatus 100 depending on a data storage purpose. For example, in the case of data for driving the electronic apparatus 100, the data may be stored in the memory embedded in the electronic apparatus 100, and in the case of data for an expansion function of the electronic apparatus 100, the data may be stored in memory detachable from the electronic apparatus 100.

The memory embedded in the electronic apparatus 100 may be implemented at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)). Additionally, the memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), and the like), external memory connectable to a USB port (e.g., USB memory), or the like.

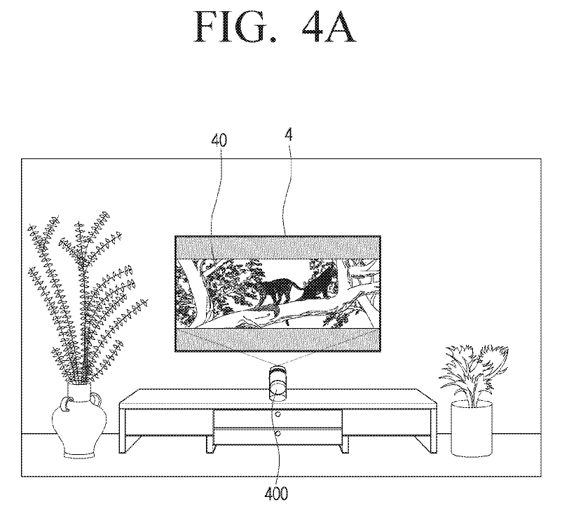

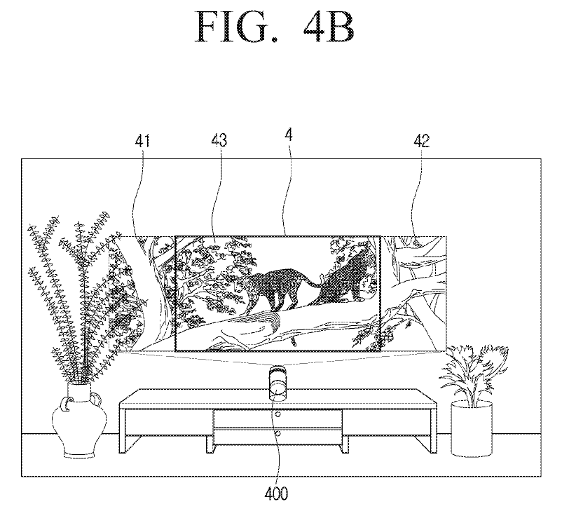

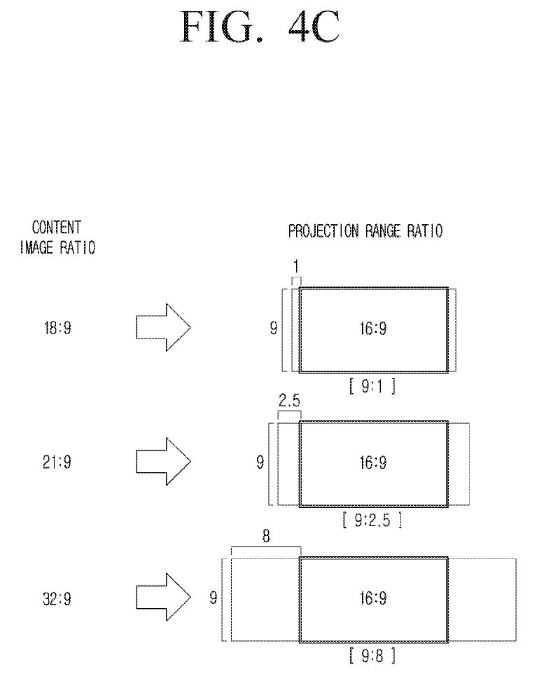

According to an embodiment, information on a projection range ratio with respect to each aspect ratio of contents provided to the external display device may be stored in the memory 130. The projection range ratio may be an aspect ratio value corresponding to a projection image output through the electronic apparatus 100. For example, the projection range ratio corresponding to contents of which an aspect ratio is 18:9 may be 9:1. Alternatively, the projection range ratio corresponding to contents of which an aspect ratio is 21:9 may be 9:2.5. However, the projection range ratio is not limited thereto, and certainly, information on a projection range ratio with respect to each different aspect ratio of contents may be stored in the memory 130. Detailed descriptions in relation to this are provided with reference to FIG. 4C.

According to an embodiment, at least one processor 140 (hereafter, a processor) may be electrically connected with the communication interface 110, the projection unit 120 and the memory 130 and include various processing circuitry to control the entire operations of the electronic apparatus 100. The processor 140 may be include one or a plurality for processors. For example, the processor 140 may execute at least one instruction stored in the memory, to perform the operations of the electronic apparatus 100 according to the various embodiments of the disclosure.

According to an embodiment, the processors 140 may be implemented as a digital signal processor (DSP) processing a digital image signal, a microprocessor, a graphics processing unit (GPU), an artificial intelligence (AI) processor, a neural processing unit (NPU), or a time controller (TCON). However, the processor is not limited thereto, and may include one or more of a central processing unit (CPU), a micro controller unit (MCU), a micro processing unit (MPU), a controller, an application processor (AP), or a communication processor (CP), an ARM processor, or may be defined as such terms. Additionally, the processor 140 may be implemented in the form of a system on a chip (SoC) with an embedded processing algorithm, large scale integration (LSI), or implemented in the form of an application specific integrated circuit (ASIC), a field programmable gate array (FPGA). Thus, the processor 140 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

According to an embodiment, the processor 140 may identify a projection area based on aspect ratio information corresponding to contents displayed on an external display device. As an example, based on aspect ratio information and image information corresponding to contents displayed on an external display device being received through the communication interface 110, the processor 140 may identify a projection area according to the received aspect ratio information corresponding to the contents and the information stored in the memory 130. Herein, the image information may refer, for example, to image information of contents displayed on an external display device, and may be pixel information corresponding to the contents.

As an example, the electronic apparatus 100 and an external display device may be in the state in which the electronic apparatus 100 and the external display device are connected communicably, and the processor 140 may receive aspect ratio information and image information corresponding to contents displayed on the external display device from the external display device through the communication interface 110. The processor 140 may identify, based on the received aspect ratio information corresponding to the contents, a projection range ratio corresponding to an aspect ratio of the displayed contents, out of information on a projection range ratio with respect to each aspect ratio of the contents provided to the external display device. For example, in the case where the aspect ratio of the displayed contents is 18:9, the processor 140 may identify, based on the information stored in the memory 130, information on a projection range ratio (9:1) corresponding to the aspect ratio (18:9).

As an example, the processor 140 may identify, based on the identified information on the projection range ratio, a projection area. For example, based on an area corresponding to the external display device being identified within the projection surface, the processor 140 may identify, according to the identified information on the projection range ratio, the projection area of which a projection image is to be output, within the projection surface. A detailed method of identifying the projection area is described in greater detail below with reference to FIGS. 4A, 4B, 4C, 5 and 6.

According to an embodiment, the processor 140 may identify the projection image that is to be output to the projection area. As one example, the projection image may refer, for example, to an image that is output through an electronic apparatus while a display image may refer, for example, to an image that is displayed through an external display device. As an example, the processor 140 may identify, based on the aspect ratio information corresponding to contents, the image information and the information stored in the memory 130, the projection image to be output to the projection area. For example, based on the information on the projection range ratio with respect to the contents being identified according to the aspect ratio information corresponding to the contents and the information on the projection range ratio with respect to each aspect ratio of the contents provided to the external display device, which is stored in the memory 130, the processor 140 may identify, according to the identified projection range ratio information and the image information of the contents, a pixel area to be output through the electronic apparatus in the image corresponding to the contents, and identify an image corresponding to the identified pixel area as the projection image.

According to an embodiment, the processor 140 may control the projection unit 120 to output the identified projection image to the identified projection area.

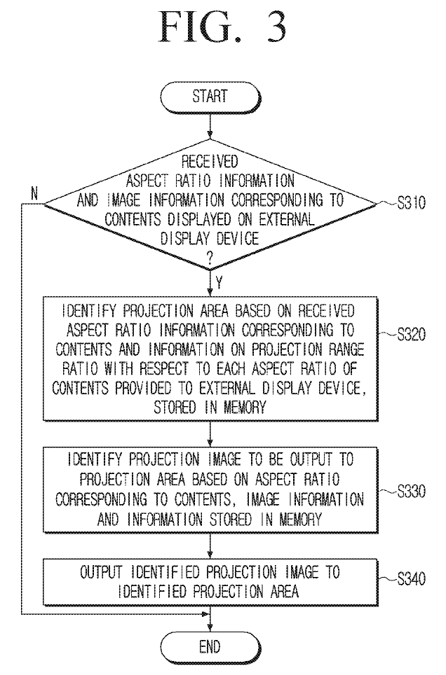

FIG. 3 is a flowchart illustrating an example method of controlling an electronic apparatus according to various embodiments.

Referring to FIG. 3, a method according to an embodiment may include determining whether aspect ratio information and image information corresponding to contents displayed on an external display device are received (S310). As an example, an electronic apparatus 100 and an external display device may be communicably connected, and a processor 140 may receive aspect ratio information and image information corresponding to contents displayed on the external display device from the external display device through a communication interface 110.

The method according to an embodiment may include identifying, based on the aspect ratio information and the image information corresponding to the contents displayed on the external display device being received (S310: Y), a projection area according to the received aspect ratio information corresponding to the contents, and information on a projection range ratio with respect to each aspect ratio of the contents provided to the external display device, which is stored in memory 130 (S320).

As an example, information on a projection range ratio with respect to each aspect ratio of contents may be stored in the memory 130, and the processor 140 may identify a projection range ratio corresponding to the received aspect ratio information. The processor 140 may identify, according to the identified projection range ratio, a projection area in which a projection image is to be output within a projection surface. For example, the processor 140 may identify, based on an area corresponding to the external display device within the projection surface being identified, the projection area in which the projection image is to be output within the projection surface according to a size of the identified area corresponding to the external display device and the identified projection range ratio.

The method according to an embodiment may include identifying the projection image to be output to the projection area according to the aspect ratio information corresponding to contents, the image information and the information stored in the memory 130 (S330). As an example, the processor 140 may identify a pixel area corresponding to the projection image in the image corresponding to the contents, according to the image information corresponding to the displayed contents and the information on the projection range ratio.

The method according to an embodiment may output the identified projection image to the identified projection area (S340). As an example, the processor 140 may output, based on the projection area and the projection image being identified, the identified projection image to the identified projection area within the projection surface through a projection unit 120.

In the above example, the electronic apparatus 100 may display part of the contents displayed on the external display device in a predetermined area within the projection surface. The electronic apparatus 100 may provide, the user, expanded contents based on a link with the external display device. Accordingly, the electronic apparatus 100 may provide an immersive viewing experience.

FIGS. 4A, 4B and 4C are diagrams illustrating an example method of displaying a projection image according to various embodiments.

According to an embodiment, the processor 140 may identify a projection image to be output through an electronic apparatus 400 and a display image to be displayed at an external display device 4.

According to an embodiment, suppose that contents 40 are provided through the external display device 4 as illustrated in FIG. 4A. As an example, the processor 140 may receive aspect ratio information and image information corresponding to contents displayed on the external display device 4 through the communication interface 110. The processor 140 may identify a projection range ratio corresponding to the contents 40 according to the received aspect ratio information corresponding to the contents and information stored in the memory 130.

As an example, as illustrated in FIG. 4C, information on projection range ratios corresponding to different content image ratios (or aspect ratios of contents) respectively may be stored. For example, suppose that an aspect ratio of the external display device 4 is 16:9. A projection range ratio (9:1) value corresponding to a content aspect ratio 18:9 may be stored in the memory 130. However, this is merely an example, and information on a projection range ratio corresponding to different aspect ratio values of the external display device 4 may also be stored in the memory 130.

As an example, the processor 140 may identify, based on a projection range ratio corresponding to the contents 40 being identified, a projection area according to the identified projection range ratio. For example, based on the projection range ratio being identified as 9:8, the processor 140 may identify, as the projection area, a predetermined area (e.g., an area adjacent to a first area) within a projection surface according to the identified projection range ratio (9:8) and information on an area (or a first area) corresponding to the external display device 4 within the projection surface. In this case, as one example, a surface area of the projection area may be a surface area proportional to a size of the area (a first area) corresponding to the external display device 4. For example, a vertical length of the external display device 4 and a vertical length of the projection area may have the same value as illustrated in FIG. 4C, but not be limited thereto.

According to an embodiment, the processor 140 may identify a projection image to be output to the projection area according to the aspect ratio information corresponding to contents, the image information and the information stored in the memory 130. The processor 140 may identify, based on the projection image to be output to the projection area being identified, a display image to be displayed at the external display device 4 according to the identified projection image and the image information of the contents. As one example, the processor 140 may identify a pixel area corresponding to the projection image within the image corresponding to the contents, and identify, as the display image, an area excluding the identified pixel area within the image corresponding to the contents. According to an embodiment, the processor 140 may transmit information on the identified display image to the external display device 4 through the communication interface 110.

According to an embodiment, the electronic apparatus 400, as illustrated in FIG. 4B, may control the projection unit 120 to output the projection image (41 or 42) to the identified projection area within the projection surface. The external display device 4 may display the identified display image 43.

In the above example, the electronic apparatus 400 may provide expanded contents based on a link with the external display device 4. In this case, based on the expanded contents being provided based on an aspect ratio of contents, the user may watch an image without a letter box. Accordingly, the user’s immersive feeling may be enhanced.

Referring back to FIG. 2, the external display device may be a main device performing operations rather than the electronic apparatus 100 according to an embodiment. As one example, the external display device may identify the projection area according to the aspect ratio information and the image information corresponding to the displayed contents, and identify the projection image to be output through the electronic apparatus 100 according to the aspect ratio information corresponding to contents, the image information and the information on the projection range ratio with respect to each aspect ratio of the contents. In this case, the information on the projection range ratio with respect to each aspect ratio of the contents provided to the external display device may be stored in the memory of the external display device. The external display device may transmit information on the identified projection area and information on the identified projection image to the electronic apparatus 100 through the communication interface, and having received the information on the identified projection area and the information on the identified projection image, the electronic apparatus 100 may also control, based on this, the projection unit 120 such that the identified projection image is output to the identified projection area.

According to an embodiment, as the projection image to be output to the projection area is identified, the external display device may identify, based on this, the display image to be displayed at the external display device. The external display device may display the identified display image through the display.

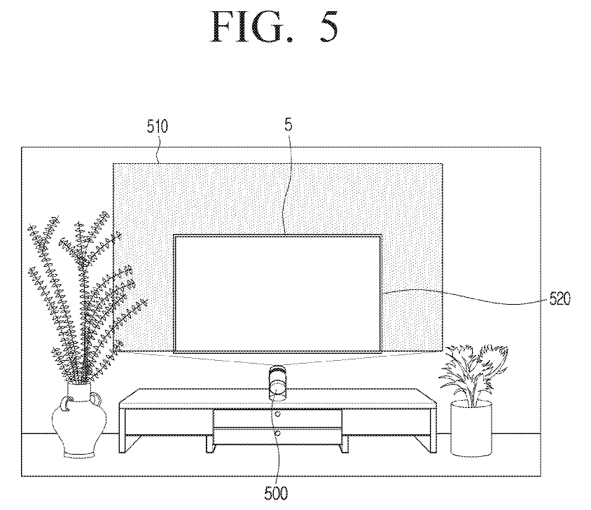

FIG. 5 is a diagram illustrating an example method of identifying a first area and a second area according to various embodiments.

Referring to FIG. 5, the processor 140 according to an embodiment may identify information on a first area 520 and information on a second area 510 within a projection surface. The first area 520 may be a first area 520 corresponding to the position of an external display device 5 within the projection surface, while the information on the first area 520 may be coordinate information corresponding to the first area 520 within the projection surface. The second area 510 may be an area excluding the first area 520 in a maximum projection area of the electronic apparatus 500, and the information on the second area 510 may be coordinate information corresponding to the second area 510 within the projection surface.

As an example, the electronic apparatus 500 may include at least one sensor, and the processor 140 may identify the information on the first area 520 corresponding to the position of the external display device 5 within the projection surface according to sensing data obtained based on the at least one sensor. For example, in the case where the projection surface is a space in a house in which the external display device 5 is installed, the processor 140 may obtain sensing data corresponding to the external display device 5 through a vision sensor included in the electronic apparatus 500. The processor 140 may identify, based on the obtained sensing data corresponding to the external display device 5, coordinate information of a vertex corresponding to the external display device 5 within the projection surface, and identify, based on the identified coordinate information of the vertex, the information on the first area 520.

As an example, the processor 140 may identify, based on the information on the first area 520, the information on the second area 510 corresponding to the maximum projection area within the projection surface. As an example, the processor 140 may identify projection angle information of the projection unit 120. A projection angle of the projection unit 120 may refer, for example, to an angle formed by the ground surface and the projection unit 120. As an example, the processor 140, may identify, based on the information on the first area 520 being identified, the information on the second area 520 according to the identified projection angle information of the projection unit 120 and the identified information on the first area 520. For example, the processor 140 may identify, based on coordinate information of a vertex corresponding to the maximum projection area and coordinate information of a vertex corresponding to the first area 520, the information on the second area 510. As an example, the processor 140 may control the projection unit 120 such that a projection image is output within the second area 510.

According to an embodiment, the external display device 5 may receive the sensing data from the electronic apparatus 500, and based on the received sensing data, identify the information on the first area 520 corresponding to the position of the external display device 5 within the projection surface and the information on the second area 510 corresponding to the maximum projection area within the projection surface. The external display device 5 may transmit the identified information on the first area 520 and the identified information on the second area 510 to the electronic apparatus 500, and the electronic apparatus 500, may control, based on this, the projection unit 120 such that a projection image is output within the second area 510.

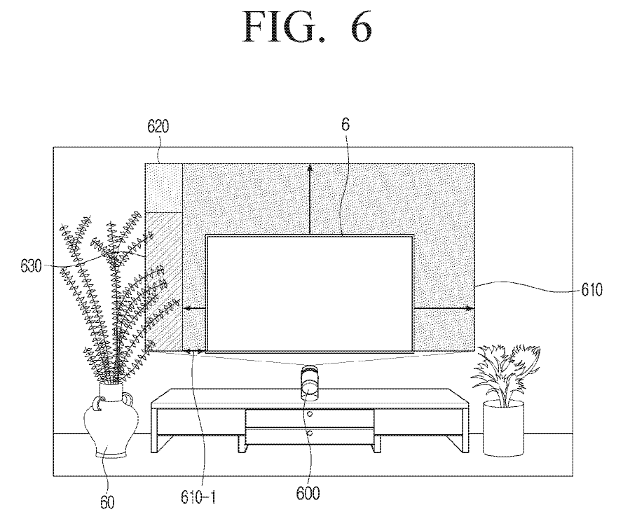

FIG. 6 is a diagram illustrating an example method of identifying a viewing obstruction area according to various embodiments.

Referring to FIG. 6, according to an embodiment, the processor 140 may identify a viewing obstruction area 630. The viewing obstruction area 630 may refer, for example, to an area in which user viewing is obstructed by an object 60 present within a second area 620 in the case where an image is output within a projection surface. As an example, the processor 140 may identify, based on the object 60 being identified within the second area 620 according to information on the second area 620 and obtained sensing data, the viewing obstruction area 630 within the projection surface based on an area corresponding to the identified object 60. For example, the electronic apparatus may include a vision sensor, and the processor 140 may identify the position of the object 60 present within the second area 620 based on sensing data obtained through the vision sensor. The processor 140 may identify, based on the position of the object 60 being identified, an area corresponding to the identified object 60 within the second area 620 as the viewing obstruction area 630. The processor 140 may identify coordinate information of a vertex corresponding to the viewing obstruction area 630 as information on the viewing obstruction area 630.

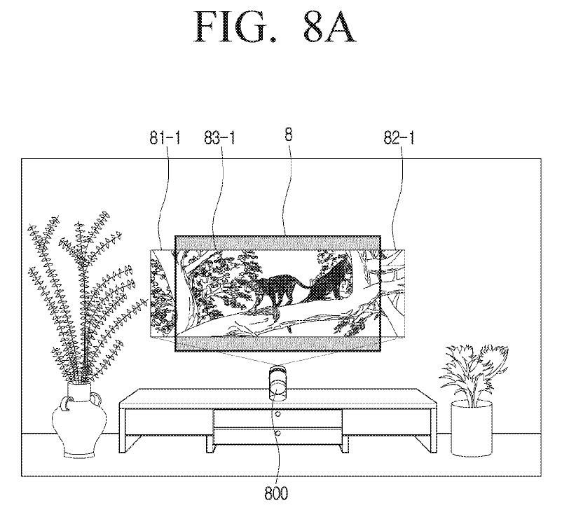

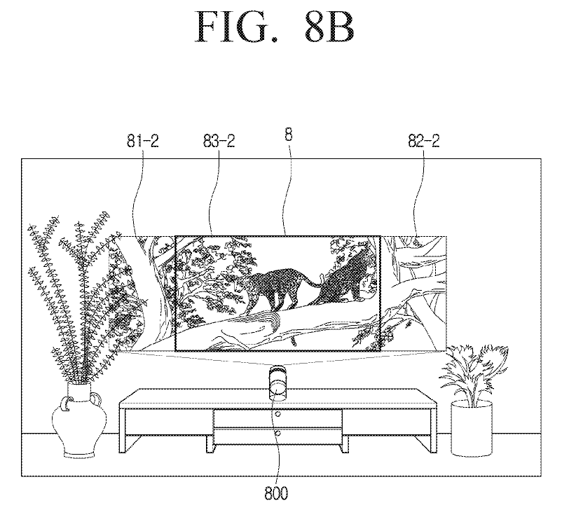

According to an embodiment, the processor 140 may update a projection image based on the information on the viewing obstruction area 630. As an example, the processor 140 may identify, based on the information on the viewing obstruction area 630, a third area 610 within the projection surface, and update the projection image such that the projection image corresponds to the identified third area 610. The third area 610 may refer, for example, to a rectangle area excluding the viewing obstruction area 630 within the second area 620. The processor 140 may identify, within the identified third area 610, a horizontal length 610-1 of an area reduced due to the viewing obstruction area 630 in the second area 620. The processor 140 may update a projection image and a display image such that the projection image and the display image correspond to the identified horizontal length 610-1. For example, the processor 140 may identify the projection image and the display image of which sizes are reduced, with no change in the aspect ratios of the projection image and display image that are output as illustrated in FIG. 8A.

According to an embodiment, the processor 140 may control the projection unit 120 such that the updated projection image is output in the area excluding the viewing obstruction area 630 within the second area 620. As an example, the processor 140 may control the projection unit 120 such that the updated projection image is output in the third area 610, and transmit information on the updated display image to an external display device 6 through the communication interface 110.

According to an embodiment, the external display device 6 may obtain sensing data from an electronic apparatus 600. The external display device 6 may identify whether the object 60 is identified within the second area 620 based on the obtained sensing data. The external display device 6 may identify, based on this, the viewing obstruction area 630 within the projection surface, and update, based on the identified viewing obstruction area 630, the projection image. The external display device 6 may transmit the updated projection image to the electronic apparatus 600, and the electronic apparatus 600 may control the projection unit 120 to output the received projection image.

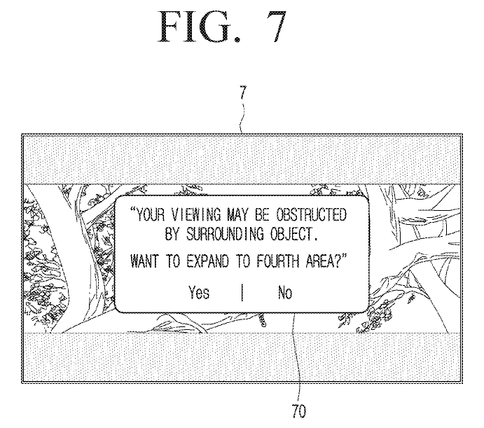

FIG. 7 is a diagram illustrating an example method of outputting a guide user interface (UI) according to various embodiments.

Referring to FIG. 7, according to an embodiment, the processor 140 may provide a guide user interface (UI) 70 for selecting any one of a projection image and an updated projection image. As an example, the processor 140, may control, based on the viewing obstruction area being identified within the projection surface, the projection unit 120 to output the guide UI 70 for selecting any one of the projection image and the updated projection image. For example, the processor 140 may control the projection unit 120 to output the guide UI 70 including text information corresponding to “User viewing may be obstructed due to a surrounding obstacle. Want to expand in a fourth output method?” Herein, the fourth output method may refer, for example, to a method of projecting contents to remove a letter box as illustrated in FIG. 4B. The processor 140 may also transmit identified information on the guide UI 70 to an external display device 7 through the communication interface 110.

According to an embodiment, the external display device 7 may also provide a guide user interface (UI) 70 for selecting any one of a projection image and an updated projection image. As an example, the external display device 7 may output, based on the viewing obstruction area being identified within the projection surface, the guide UI 70 for selecting any one of the projection image and the updated projection image.

FIGS. 8A and 8B are diagrams illustrating an example method of outputting an image according to various embodiments.

According to an embodiment, the processor 140 may output any one of a projection image and an updated projection image based on an input (e.g., a user input).

Referring to FIG. 8A, as an example, an external display device 8 may transmit, based on a user input for projecting contents by avoiding a viewing obstruction area being received, the received user input to the electronic apparatus 800. The processor 140 may control, based on the user input for projecting contents by avoiding a viewing obstruction area being received through the communication interface, the projection unit 120 to output an updated projection image 81-1 and 82-1. A method of obtaining the updated projection image 81-1 and 82-1 is described above with reference to FIG. 6, and accordingly, detailed descriptions thereof are omitted.

As an example, the external display device 8 may transmit, in the case where a user input for projecting contents so as to remove a letter box in the external display device 8 being received, the received user input to the electronic apparatus 800. The processor 140 may control, based on the user input for projecting contents so as to remove a letter box through the communication interface being received, the projection unit 120 to output the updated projection image 81-2 and 82-2 as illustrated in FIG. 8B.

According to an embodiment, the processor 140 may identify, based on the received user input, any one of a display image or an updated display image, and transmit information on any one identified image to the external display device 8 through the communication interface. The external display device 8 may display any one of an output image or an updated output image.

As an example, the processor 140 may transmit, based on the user input for projecting contents by avoiding a viewing obstruction area being received as illustrated in FIG. 8A, an updated display image 83-1 to the external display device 8 through the communication interface 110. As an example, the processor 140 may also transmit, based on the user input for projecting contents so as to remove a letter box in the external display device 8 being received as illustrated in FIG. 8B, an updated display image 83-2 to the external display device 8 through the communication interface 110.

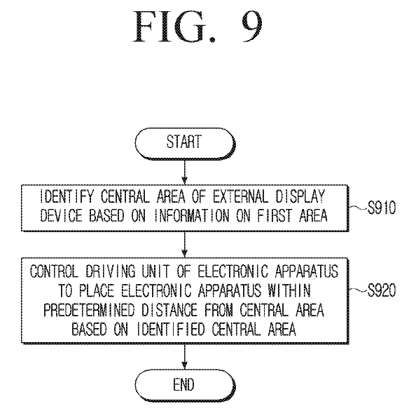

FIG. 9 is a flowchart illustrating an example method of controlling an electronic apparatus according to various embodiments.

Referring to FIG. 9, according to an embodiment, a method may include identifying a central area of an external display device based on information on a first area (S910). As an example, the processor 140 may identify information on a first area corresponding to the external display device within a projection surface according to sensing data obtained based on at least one sensor. The processor 140 may identify, based on the information on the first area being identified, a position corresponding to the center of the first area as a central area of the external display device. For example, the processor 140 may identify the position corresponding to the center of the first area based on a position of a vertex corresponding to the first area.

According to an embodiment, the method may include controlling a driving unit of an electronic apparatus 100 such that the electronic apparatus 100 is placed within a predetermined distance from the central area based on the identified central area (S920). As an example, the electronic apparatus 100 may further include a driving unit for allowing the electronic apparatus 100 to move. The processor 140 may control, based on the central area of the external display device being identified, the driving unit such that the center (e.g., center of gravity) of the electronic apparatus 100 is placed within a predetermined distance from the central area of the external display device as illustrated in FIGS. 8A and 8B.

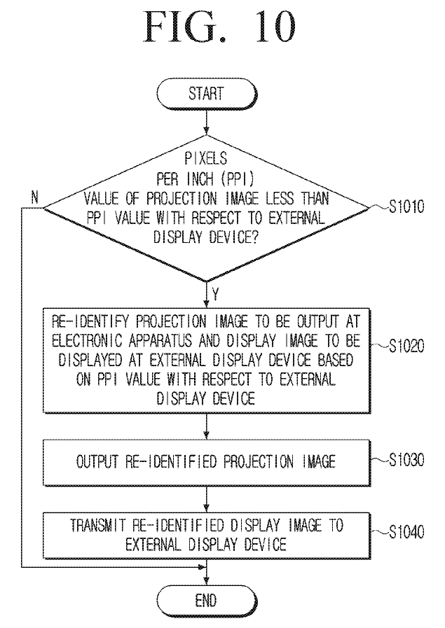

FIG. 10 is a flowchart illustrating an example method of re-identifying a projection image and a display image according to various embodiments.

Referring to FIG. 10, according to an embodiment, the control method may include determining whether a pixels per inch (PPI) value of a projection image is less than a PPI value with respect to the external display device (S1010).

As an example, the processor 140 may identify a PPI value with respect to the external display device. For example, the processor 140 may identify the PPI value with respect to the external display device from the external display device through a communication interface 110. A PPI value with respect to an external display device communicably connected with the electronic apparatus 100 may be stored in the memory of the electronic apparatus 100, and the processor 140 may also identify the PPI value with respect to the external display device based on the information stored in the memory.

As an example, the processor 140 may identify, based on a projection image being identified based on image information corresponding to contents, a PPI value of the identified projection image, and compare the PPI value of the identified projection image with the PPI value with respect to the external display device to determine whether the pixels per inch (PPI) value of the projection image is less than the PPI value with respect to the external display device.

According to an embodiment, the method may include re-identifying, based on the pixels per inch (PPI) value of the projection image being less than the PPI value with respect to the external display device (S1010: Y), a projection image to be output at the electronic apparatus 100 and a display image to be displayed at the external display device based on the PPI value with respect to the external display device (S1020). As an example, the processor 140 may identify a first image of which a PPI value of an image corresponding to the contents is identical with the PPI value with respect to the external display device based on the image information corresponding to the contents. The processor 140 may identify a projection image and a display image corresponding to the first image based on information on the identified first image, aspect ratio information corresponding to the contents and information stored in the memory.

Then, according to an embodiment, the method may include outputting the re-identified projection image (S1030). As one example, the processor 140 may control the projection unit 120 to output a projection image corresponding to the identified first image to a projection area.

According to an embodiment, the method may include transmitting the re-identified display image to the external display device (S1040). As one example, the processor 140 may transmit information on a display image corresponding to the first image to the external display device through the communication interface 110.

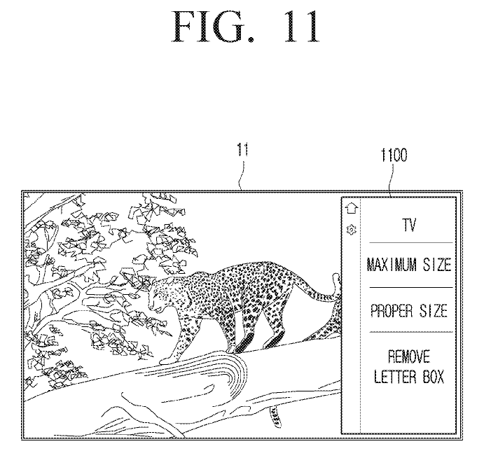

FIG. 11 is a diagram illustrating an example method of providing a UI menu according to various embodiments.

Referring to FIG. 11, according to an embodiment, the processor 140 may identify at least one of a projection image to be output through the projection unit 120 and a display image to be displayed at an external display device 11 based on a user command received through a UI menu 1100 for selecting an output method of contents. As one example, the external display device 11 may display the UI menu 1100 for selecting an output method of contents, and based on this, may receive a user command for selecting an output method of contents from the user. The processor 140 may receive, based on the user command being received, a user command from the external display device 8 through the communication interface 110. The processor 140 may identify, based on the received user command, the projection image to be output through the projection unit 120 and the display image to be displayed at the external display device 11.

According to an embodiment, the UI menu 1100 may include at least one of a first output method in which contents are output only at the external display device 11 (e.g., a “TV mode”), a second output method in which contents are projected to a maximum projection area (e.g., a “maximum size mode”), a third output method in which contents are projected by avoiding a viewing obstruction area (e.g., a “proper size mode”), and a fourth output method in which contents are projected in the way that a letter box is removed (e.g., a “letter box removing mode”).

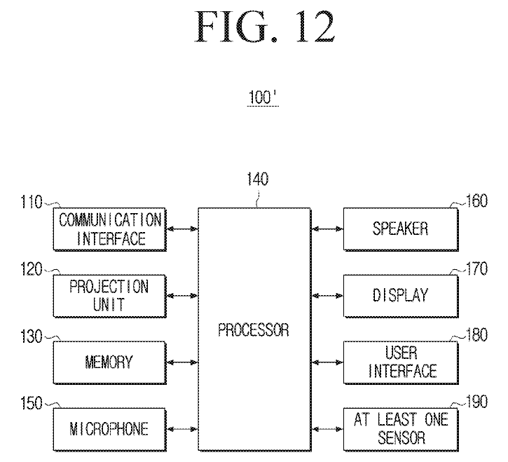

FIG. 12 is a block diagram illustrating an example configuration of an electronic apparatus according to various embodiments.

Referring to FIG. 12, an electronic apparatus 100' may include a communication interface (e.g., including communication circuitry) 110, a projection unit (e.g., including a projector) 120, memory 130, one or more processors (e.g., including processing circuitry) 130, a microphone 150, a speaker 160, a display 170, a user interface (e.g., including various circuitry) 180 and at least one sensor 190. Among the elements illustrated in FIG. 12, detailed descriptions of elements overlapping the elements illustrated in FIG. 2 may not be repeated here.

The microphone 150 may refer, for example, to a module obtaining a sound and converting the sound into an electrical signal, and may be a condenser microphone, a ribbon microphone, a moving coil microphone, a piezoelectric microphone, a carbon microphone, or a micro electro mechanical system (MEMS) microphone. Additionally, the microphone may be implemented based on an omnidirectional method, a bidirectional method, a uni-directional method, a sub cardioid method, a super cardioid method, or a hyper cardioid method.

The speaker 160 may be comprised of a tweeter for replaying a sound in a high vocal range, a midrange for replaying a sound in an intermediate vocal range, a woofer for replaying a sound in a low vocal range, a subwoofer for replaying a sound in an extremely low vocal range, an enclosure for controlling resonance, a crossover network dividing an electrical signal frequency input to the speaker based on each band, and the like.

The speaker 160 may output an acoustic signal to the outside of the electronic apparatus 100'. The speaker 160 may output a multimedia replay, a recording replay, various notification sounds, a voice message and the like. The electronic apparatus 100' may include an audio output device such as a speaker 160, but may include an input device such as an audio output terminal. In particular, the speaker 160 may provide obtained information, information processed/generated based on the obtained information, a response result or an operation result with respect to a user voice and the like, in the form of a voice.

The display 170 may be implemented as a display including a self light emitting element, or a display including a non-self light emitting element and backlight. For example, the display may be implemented as various types of displays such as a liquid crystal display (LCD), an organic light emitting diode (OLED) display, a light emitting diode (LED), a micro LED, a mini LED, a plasma display panel (PDP), a quantum dot (QD) display, a quantum dot light-emitting diode and the like. In the display 170, driving circuitry implementable in the form of an a-si TFT, a low temperature poly silicon (LTPS) TFT, an organic TFT (OTFT) and the like, and a backlight unit may be included together. The display 170 may be implemented as a touch screen coupled with a touch sensor, a flexible display, a rollable display, a 3D display, a display in which a plurality of display modules is physically connected, and the like. The processor 140 may control the display 170 to output an output image obtained according to the above-described embodiments. Herein, the output image may be an image of high resolution greater than or equal to 4K or 8K. The output image may also be a game image according to an embodiment.

The user interface 180 is an element for performing an interaction of the electronic apparatus 100' with the user. For example, the user interface 180 may include various circuitry including at least one of a touch sensor, a motion sensor, a button, a jog, a dial, a switch, a microphone or a speaker, but not be limited thereto.

The at least one sensor 190 (hereafter, a sensor) may include various types of a plurality of sensors. The sensor 190 may measure a physical amount or sense an operation state of the electronic apparatus 100', and convert the measured or sensed information into an electrical signal. The sensor 190 may include a camera, and the camera may include a lens that focuses, to an image sensor, visible light or other optical signals reflected and received from an object, and an image sensor that senses visible light or other optical signals. Herein, the image sensor may include a 2D pixel array that is divided into a plurality of pixels. Alternatively, the at least one sensor 190 may include a temperature sensor or an infrared sensor.

In the above examples, the electronic apparatus 100' may display part of contents displayed on the external display device in the predetermined area within the projection surface. The electronic apparatus 100' may provide, to the user, expanded contents based on a link with the external display device. Accordingly, the electronic apparatus 100' may provide an immersive viewing experience.

The methods, according to the various embodiments described above, may be implemented in the form of an application that is installable in an existing electronic apparatus. The methods, according to the various embodiments described above, may be performed using a trained neural network based on deep learning (or a deeply trained neural network), e.g., a trained network model. The methods, according to the various embodiments described above, may be implemented only based on an upgrade of software of an existing electronic apparatus or an upgrade of hardware. Various embodiments set forth herein may be performed through an embedded server provided in an electronic apparatus or an external server of an electronic apparatus.

Various embodiments described above may be implemented with software including instructions stored in a storage medium readable by a machine (e.g., a computer). The machine, as a device capable of calling the stored instructions from the storage media and operating according to the called instructions, may include a display device (e.g., display device A) according to the disclosed embodiments. Based on instructions executed by a processor, the processor may perform functions corresponding to the instructions directly or using other elements under the control of the processor. The instructions may include a code generated or executed by a compiler or an interpreter. The machine-readable storage medium may be provided in the form of a non-transitory storage medium. Herein, the “non-transitory” storage medium may not include a signal and the storage medium is tangible, while the term does not differentiate semi-permanent or temporary storage of data in the storage medium.

According to the various embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store^{TM}). In the case of online distribution, at least part of the computer program product may be stored at least temporarily, or provided temporarily in a storage medium such as a manufacturer’s server, a server of an application store, or memory of a relay server.

Each of the elements (e.g., a module or a program) according to the various embodiments described above may be comprised of a single entity or a plurality of entities, and some of the corresponding sub elements described above may be omitted, or another sub element may be further included in the various embodiments. Alternatively or additionally, some of the elements (e.g., modules or programs) may be integrated into one entity to perform identical or similar functions performed by each corresponding element prior to integration. Operations performed by a module, a program, or another element, according to the various embodiments, may be executed sequentially, in parallel, repetitively, or heuristically, or at least some of the operations may be executed in a different order, omitted, or may add a different operation.

While example embodiments of the present disclosure are illustrated and described above, embodiments of the disclosure are not limited to specific embodiments set forth herein, and certainly, various modifications thereof may be made by those skilled in the art to which the disclosure pertains, without departing from the subject matter of the disclosure, including the claims, and should not be understood as separating from the technical spirit or prospect of the disclosure. It will also be understood than any of the embodiment(s) described herein may be use in conjunction with any other embodiment(s) described herein.

What is claimed is:

1. An electronic apparatus comprising:
a communication interface comprising communication circuitry;
a projection unit including a projector;
memory storing information on a projection range ratio with respect to each aspect ratio of contents provided to an external display device; and
at least one processor, comprising processing circuitry,
wherein at least one processor, individually and/or collectively, is configured to cause the electronic apparatus to:
identify, based on aspect ratio information and image information corresponding to contents displayed on the external display device being received through the communication interface, a projection area according to the received aspect ratio information corresponding to contents and information stored in the memory;
identify, based on the aspect ratio information corresponding to contents, the image information and the information stored in the memory, a projection image to be output to the projection area; and
control the projection unit to output the identified projection image to the identified projection area.

2. The electronic apparatus of claim 1,
wherein at least one processor, individually and/or collectively, is configured to cause the electronic apparatus to: identify, based on a projection image to be output to the projection area being identified, a display image to be displayed at the external display device according to the identified projection image and the image information of contents, and
transmit information on the identified display image to the external display device through the communication interface.

3. The electronic apparatus of claim 1 further comprising:
at least one sensor,
wherein at least one processor, individually and/or collectively, is configured to cause the electronic apparatus to: identify, based on sensing data obtained through the at least one sensor, information on a first area corresponding to a position of the external display device within a projection surface,
identify, based on size information of the external display device and the information on a first area, information on a second area corresponding to a maximum projection area within the projection surface, and
control the projection unit to output the projection image within the second area.

4. The electronic apparatus of claim 3,
wherein at least one processor, individually and/or collectively, is configured to cause the electronic apparatus to: identify, based on an object being identified in the second area according to the information on a second area and the obtained sensing data, a viewing obstruction area within the projection surface according to an area corresponding to the identified object,
update the projection image based on information on the viewing obstruction area and the aspect ratio information of contents, and
control the projection unit to output the updated projection image within an area excluding the viewing obstruction area in the second area.

5. The electronic apparatus of claim 4,
wherein at least one processor, individually and/or collectively, is configured to cause the electronic apparatus to: based on a viewing obstruction area being identified within the projection surface, control the projection unit to output a guide user interface (UI) for selecting any one of the projection image and the updated projection image, and/or transmit information on the identified guide UI to the external display device through the communication interface.

6. The electronic apparatus of claim 5,
wherein at least one processor, individually and/or collectively, is configured to cause the electronic apparatus to: based on an input for selecting any one of the projection image and the updated projection image being received through the communication interface, control the projection unit to output any one of the projection image and the updated projection image according to the received input.

7. The electronic apparatus of claim 3 further comprising:
a driving unit comprising circuitry configured to move the electronic apparatus,
wherein at least one processor, individually and/or collectively, is configured to cause the electronic apparatus to: identify, based on the information on a first area, a central area of the external display device, and
control the driving unit to place the electronic apparatus within a specified distance from the central area based on the identified central area.

8. The electronic apparatus of claim 1,
wherein at least one processor, individually and/or collectively, is configured to cause the electronic apparatus to: re-identify, based on a Pixels Per Inch (PPI) value of the projection image being identified as less than a PPI value with respect to the external display device, a projection image to be output at the electronic apparatus and a display image to be displayed at the external display device according to the PPI value with respect to the external display device,
control the projection unit to output the re-identified projection image, and
transmit the re-identified display image to the external display device through the communication interface.

9. The electronic apparatus of claim 1,
wherein at least one processor, individually and/or collectively, is configured to cause the electronic apparatus to: identify, based on a command received through a UI menu for selecting an output method of contents, at least one of a projection image to be output through the projection unit and a display image to be displayed at the external display device, and
the UI menu includes at least one of a first output method in which contents are output only at the external display device, a second output method in which contents are projected in a maximum projection area, a third output method in which contents are projected by avoiding a viewing obstruction area, and a fourth output method in which contents are projected in a way that a letter box is removed.

10. A method of controlling an electronic apparatus, the method comprising:
identifying, based on aspect ratio information and image information corresponding to contents displayed on an external display device being received, a projection area according to the received aspect ratio information corresponding to contents and information on a projection range ratio with respect to each aspect ratio of contents provided to the external display device, stored in memory;
identifying, based on the aspect ratio information corresponding to contents, the image information and the information stored in the memory, a projection image to be output to the projection area; and
outputting the identified projection image to the identified projection area.

11. The method of claim 10 further comprising:
identifying, based on a projection image to be output to the projection area being identified, a display image to be displayed at the external display device according to the identified projection image and the image information of contents; and
transmitting information on the identified display image to the external display device.

12. The method of claim 10 further comprising:
identifying, based on sensing data obtained through at least one sensor, information on a first area corresponding to a position of the external display device within a projection surface; and
identifying, based on size information of the external display device and the information on a first area, information on a second area corresponding to a maximum projection area within the projection surface,
wherein the outputting includes outputting the projection image within the second area.

13. The method of claim 12 further comprising:
identifying, based on an object being identified in the second area according to the information on a second area and the obtained sensing data, a viewing obstruction area within the projection surface according to an area corresponding to the identified object; and
updating the projection image based on information on the viewing obstruction area and the aspect ratio information of contents, and
wherein the outputting includes outputting the updated projection image within an area excluding the viewing obstruction area in the second area.

14. The method of claim 13 further comprising:
outputting, based on a viewing obstruction area being identified within the projection surface, a guide user interface (UI) for selecting any one of the projection image and the updated projection image, and/or transmitting information on the identified guide UI to the external display device.

15. A non-transitory computer-readable recording medium storing computer instructions which, when executed by at least one processor, comprising processing circuitry, of an electronic apparatus, individually and/or collectively, cause the electronic apparatus to perform operations comprising:
identifying, based on aspect ratio information and image information corresponding to contents displayed on an external display device being received, a projection area according to the received aspect ratio information corresponding to contents and information on a projection range ratio with respect to each aspect ratio of contents provided to the external display device, stored in memory;
identifying, based on the aspect ratio information corresponding to contents, the image information and the information stored in the memory, a projection image to be output to the projection area; and
outputting the identified projection image to the identified projection area.
